(19) United States
(12) Patent Application Publication
(10) Pub. No.: US 2022/0411108 A1
(43) Pub. Date: Dec. 29, 2022

(54) Rocket bundled with a small flighting system

(71) Applicant: Yang Li, Wilmington, DE (US)

(72) Inventor: Yang Li, Wilmington, DE (US)

(21) Appl. No.: 17/361,022

(22) Filed: Jun. 28, 2021

Related U.S. Application Data
(60) Provisional application No. 63/163,643, filed on Jan. 1, 0001.

(51) Int. Cl. B64G 1/00; B64G 1/14

(52) U.S. Cl. CPC B64G 1/005; B64G 1/14

(57) ABSTRACT

The present invention presents an adjustable speed reusable rocket with attachable wings system which is optimized for multiple purpose, such as space travel, high-speed long-distance travel between different addresses on earth, etc. The rocket system comprises an adjustable speed rocket propulsion system (rocket booster), an attachable wings system, a payload or space shuttle and may include slider wings system, etc. Firstly, the rocket system flies at a lift force caused by the attachable wings system at a low speed (e.g., Mach 0.5˜3). While the rocket system reaches relatively high altitude (e.g., 25,000 meters), at this altitude, the air density is extremely low comparing with the surface of earth at zero sea level, and then the attachable wings system may detach from the rocket system and fly to a designated location as a glider or by its engine on a runway, and the rocket system begins to fully initiate propulsion system and exert the payload to forward at a super high speed. Comparing with rocket fully initiate propulsion system from earth surface, the aerodynamic friction and the aerodynamic heat caused by air is extremely small and low.

### CROSS-REFERENCE TO RELATED APPLICATION

This application claims priority to and the benefit of U.S. Provisional Application No. 63/163,643, filed Mar. 19, 2021, which prior application is incorporated by reference herein and made part hereof.

### FIELD OF THE DISCLOSURE

The present disclosure is generally related to a modified rocket system.

### BACKGROUND

The conventional rocket system includes a propulsion system (rocket booster), one or more payloads (for cargo or crew), or space shuttle. The rocket launches at a vertical configuration, the booster exerts propulsion to propel rocket forward, when reaches to the designated altitude, the booster separates with the payload or space shuttle, and the payload or space shuttle ignites its propulsion system and forward to a designated location.

Most spaceports are located around the equator, since the equator has the fastest speed of Earth surface, a rocket launched from the sites near the equator towards the east direction will get an initial boost equal to the velocity of Earth surface. The space travelers need to arrive near equator than fly into space.

Additional, in the atmosphere, as the altitude increasing, the air density gradually decreases. When the altitude reaches to a relatively high altitude (e.g., 25,000 meters) the air density becomes extremely low, almost is 1/30^{th} of the air density of the Earth surface at zero sea level. The aerodynamic drag is related to air density, so at the same high speed, the aerodynamic drag at 25,000 meters is 1/30^{th} of the aerodynamic drag on the Earth surface. The present disclosure attempts to resolve the challenges.

### SUMMARY

The summary is provided to broadly introduce the invention which is not intended to introduce the key feature. The details are described in the below Detail Description section.

In some embodiment, a traveling device includes an adjustable speed reusable rocket propulsion system (e.g., rocket booster, rocket first stage), an attachable wings system configured to attach or detach with the adjustable speed rocket booster, one or more payloads or space shuttles, and may include an attachable slider wings or attachable tail etc.

To launch the space shutter or payload, in one embodiment, the adjustable speed rocket booster propels the whole system to fly at a low speed, the income air and the attachable wings execute a lift force to perform the whole rocket system to a designated high altitude. With the altitude increasing, the air density decreasing. When the rocket and wings system reach to a designated altitude, the income air and attachable wings system can not execute more lift force to power rocket to reach higher altitude, and then the attachable wings system to separate with the whole rocket system, simultaneously, the reusable rocket system perform fully propulsion and power the payload or space shuttle to higher altitude, and the adjustable wings system flies to a designated position and lands as a glider on a runway in a horizontal configuration.

In some embodiment, the attachable wing system separate with the whole rocket system during flying, it flies back or to a designated location as a glider. The rocket booster separate with the payload and space shuttle at a higher altitude and land on the ground in a vertical configuration.

In some embodiment, the adjustable speed rocket and attachable wing system may include a second small wing or glider wing, after the rocket booster separates with payload or space shuttle during flying, the rocket booster may return or fly to a designated Earth location by performing the small wing or glider wing.

### BRIEF DESCRIPTION OF THE DRAWING

To complete understand the present disclosure and features and advantages thereof, referencing the provided following description when read in conjunction with the companying figures, background, technical field of the disclosure, and headings. In the present disclosure and different figures, the identical numerals and/or letters may be repeated should be considered as the same element or a functionally equivalent element.

FIG. 1A is a perspective view of the adjustable speed rocket with attachable wings system, according to an aspect of the present disclosure.

FIG. 1B is an exploded perspective view of the adjustable speed rocket with attachable wings system shown in FIG. 1A.

FIG. 1C is a perspective view of the adjustable speed rocket with attachable wings system when the rocket booster is hanging under the attachable wings system.

FIG. 2 is a side perspective view the adjustable speed rocket with attachable wings system shown in FIG. 1A.

FIG. 3A is a perspective view of the adjustable speed rocket with attachable wings system includes glider wings as well.

FIG. 3B is a perspective view of the adjustable speed rocket with attachable wings system and the wings system includes engine system.

FIG. 4A and 4B are perspective views of the adjustable speed rocket with attachable wings system includes a mounting system between rocket and attachable wings.

FIG. 5A is a timeline view of the rocket with attachable wings system illustrates one embodiment of the launching and landing process that the rocket booster lands with glider wings on a runway at a horizontal configuration.

FIG. 5B is a timeline view of the rocket with attachable wings system illustrates another embodiment of the launching and landing process that the rocket booster lands on the ground in a vertical configuration.

FIG. 5C is a timeline view of the rocket with attachable wings system illustrates another embodiment of the launching and landing process that the rocket booster and attachable wings system separate with the payload or space shuttle together.

FIG. 5D is a timeline view of the rocket with attachable wings system illustrates another embodiment of the launching and landing process that the rocket booster with space shuttle together lands at another Earth location on a runway in a horizontal configuration.

FIG. 6A is a perspective view of the rocket with attachable wings system illustrates the attachable wings move back to a designated position for preparing the rocket booster separates with the payload or space shuttle.

FIG. 6B is a perspective view of the rocket with attachable wings system illustrates the attachable wings fold back for preparing the rocket booster fully ignite the propulsion system.

FIG. 6C is a perspective view of the rocket with attachable wings system illustrates the part of the attachable wings draw back into another part of the wings for preparing the rocket booster fully ignite the propulsion system.

FIG. 6D is a perspective view of the rocket with attachable wings system illustrates the attachable wings include rocket propellant containers.

FIG. 7 is a perspective view of the rocket with attachable wings system illustrates at least one jet engine bundled with the rocket booster.

FIG. 8 is a perspective view illustrates one embodiment of the rocket with attachable wings system includes more than one rocket boosters to carry multiply space shuttles or payloads.

FIG. 9A is a perspective view illustrates another embodiment of the rocket with attachable wings system includes more than one rocket boosters to carry multiply space shuttles or payloads.

FIG. 9B is a perspective view illustrates parallel holders deposited on the wings system for holding or hanging the payload space shuttle and rocket booster.

FIG. 10 is a perspective view illustrates another embodiment of the rocket with attachable wings system includes more than one rocket boosters to carry multiply space shuttles or payloads.

FIG. 11 is a perspective view illustrates another embodiment of the rocket with attachable wings system includes more than one rocket boosters to carry multiply space shuttles or payloads.

FIG. 12 is a perspective view illustrates another embodiment of the rocket with attachable wings system includes more than one rocket boosters to carry multiply space shuttles or payloads.

### DETAIL DESCRIPTION

It is to be understood that the present disclosure is not limited to the details of the description, and various other modifications and applications can be considered. Further changes of the device, design, configuration, or methods will be made to those skilled in the art without deviating from the true spirit of the scope of the disclosure herein described, therefore, the detail of description in the disclosure should be interpreted as illustration not to limit the scope of the invention.

The present disclosure is directed to an adjustable speed reusable rocket with attachable wings system and methods, which performs space travel or long-distance super high-speed travel between different Earth locations. The reusable rocket with attachable wings system includes an adjustable speed reusable rocket propulsion system (e.g., rocket booster, rocket first stage), an attachable wings system configured to attach or detach with the adjustable speed rocket booster, one or more payloads or space shuttles, and may include an attachable slider wings or attachable tail etc. The adjustable speed rocket includes multiply combustion chambers and nozzles, a control system may adjust the booster speed according to ignite or cease different numbers of combustion chambers and nozzles to execute the different propulsion force. Part of the booster body may be manufactured to a flat shape to fit the attachable wings system.

To launch the space shutter or payload, in one embodiment, the adjustable speed rocket booster propels the whole system to fly at a low speed, the income air and the attachable wings execute a lift force to perform the whole rocket system to a designated high altitude. With the altitude increasing, the air density decreasing, as shown in table 1, when altitude arrives 25,000 meters, the air density (0.0408 kg/m3) is 1/30^{th} of air density at zero sea level (1.225 kg/m3). The aerodynamic drag is related to the air density, which means when the rocket system reaches to 25,000 meters, the aerodynamic drag exerts on the rocket system is 1/30^{th} aerodynamic drag exerts on the rocket system at zero sea level at the same speed. At this situation, due to the air density is extremely low, the income air and attachable wings system can not execute more lift force to power rocket to reach higher altitude. An input command occurred by the program performs the attachable wings system to separate with the whole rocket system, simultaneously, another command initiates the reusable rocket system fully propulsion and performs the payload or space shuttle to higher altitude, and the adjustable wings system flies to a designated position and lands as a glider on a runway in a horizontal configuration.

U.S. Standard Atmosphere Air Properties—Si Units

TABLE 1

| Geo | | | | | |
|---|---|---|---|---|---|
| potential | | Accel- | | | |
| Altitude | | eration | | | Dynamic |
| above | Temper- | of | Absolute | | Viscosity |
| Sea Level | ature | Gravity | Pressure | Density | - μ - |
| - h - | - t - | - g - | - p - | - ρ - | (10⁻⁵ |
| (m) | (° C.) | (m/s²) | (10⁴ N/m²) | (kg/m³) | N s/m²) |
| −1000 | 21.50 | 9.810 | 11.39 | 1.347 | 1.821 |
| 0 | 15.00 | 9.807 | 10.13 | 1.225 | 1.789 |
| 1000 | 8.50 | 9.804 | 8.988 | 1.112 | 1.758 |
| 2000 | 2.00 | 9.801 | 7.950 | 1.007 | 1.726 |
| 3000 | −4.49 | 9.797 | 7.012 | 0.9093 | 1.694 |
| 4000 | −10.98 | 9.794 | 6.166 | 0.8194 | 1.661 |
| 5000 | −17.47 | 9.791 | 5.405 | 0.7364 | 1.628 |
| 6000 | −23.96 | 9.788 | 4.722 | 0.6601 | 1.595 |
| 7000 | −30.45 | 9.785 | 4.111 | 0.5900 | 1.561 |
| 8000 | −36.94 | 9.782 | 3.565 | 0.5258 | 1.527 |
| 9000 | −43.42 | 9.779 | 3.080 | 0.4671 | 1.493 |
| 10000 | −49.90 | 9.776 | 2.650 | 0.4135 | 1.458 |
| 15000 | −56.50 | 9.761 | 1.211 | 0.1948 | 1.422 |
| 20000 | −56.50 | 9.745 | 0.5529 | 0.08891 | 1.422 |
| 25000 | −51.60 | 9.730 | 0.2549 | 0.04008 | 1.448 |
| 30000 | −46.64 | 9.715 | 0.1197 | 0.01841 | 1.475 |
| 40000 | −22.80 | 9.684 | 0.0287 | 0.003996 | 1.601 |
| 50000 | −2.5 | 9.654 | 0.007978 | 0.001027 | 1.704 |

Additionally, in some embodiment, the attachable wings system may include one or more engines may propel the whole system to fly at a low speed. In some embodiment, the wings system engines can not power the whole rocket to reach a designated high altitude alone, so the wings system engines collaborate with the adjustable speed rocket to propel the whole rocket system to reach to the designated high altitude at a low speed. In some embodiment, the wings system may not separate with rockets system during flying (e.g., two rockets combine with attachable wings system), they both fly to a designated location and land on a runway at horizontal configuration after separating with the payload or space shuttle.

There are some advantages about this disclosure because the air density is extremely low at relative high altitude, the rocket booster performs fully propulsion at this situation, the aerodynamic drag and heat caused by aerodynamic friction are extremely low. These methods help the rocket system reduces the launching cost, maintenance cost, and save rocket propellant etc. These methods also can be practiced in long-distance high speed different earth locations travel and cut the travel time into one or half hour comparing with the conventional economical planes need a few hours or over 10 hours to travel the same distance.

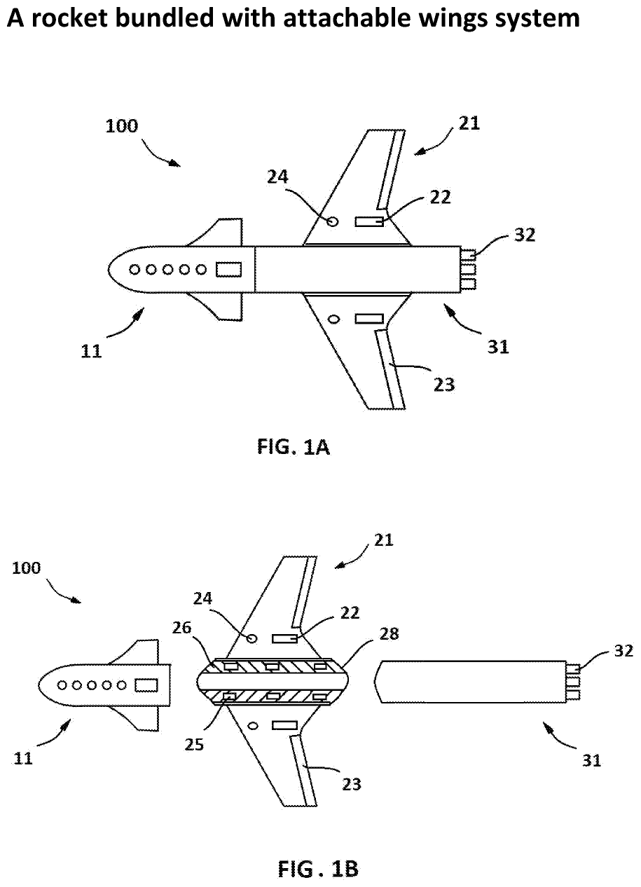

FIG. 1A is a perspective view of an adjustable speed reusable rocket with attachable wings system 100 includes a payload or a space shuttle 11, an adjustable speed reusable rocket system 31 (e.g., rocket booster, rocket first stage), an attachable wings system 21. FIG. 1B is an

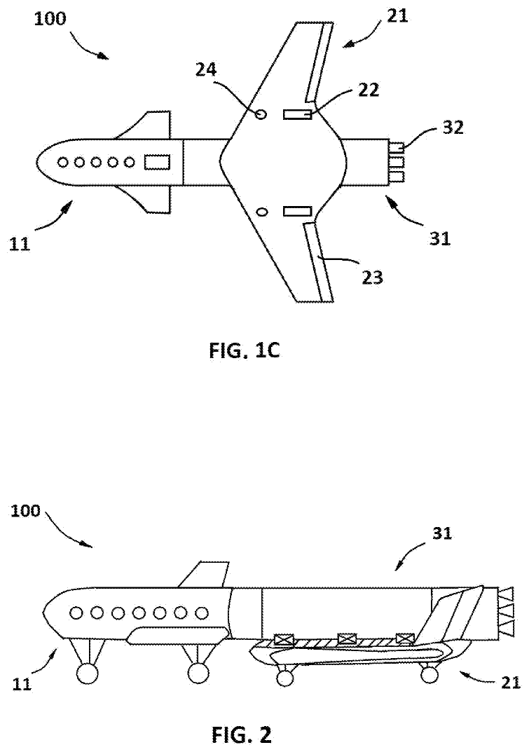

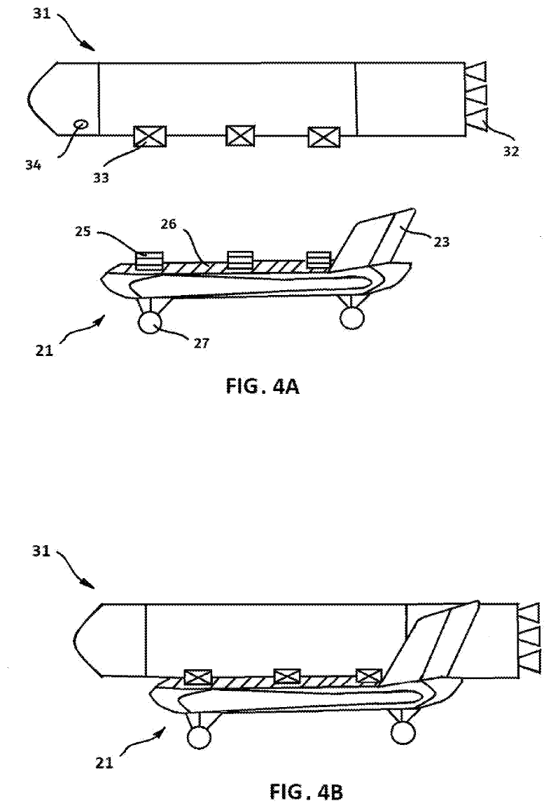

exploded view of the rocket with attachable wings system 100. The adjustable speed reusable rocket 31 may include multiply combustion chambers and nozzles 32, a control system may adjust the rocket booster 31 speed according to ignite or cease different numbers of combustion chambers and nozzles 32 to execute the different propulsion force. The wing system may include a center holder 28 for holding the reusable rocket system 100 or the reusable rocket 31 may hang under the wings system 21 (see FIG. 1C), and wings are deposited on two opposite sides of the center holder 28. A mounting system 26 and actuators 25 may be configured on the holder 28 for bundling with rocket system 31. The wings system 21 may have one or more fins 23 for balance and stability, and the wings system and reusable rocket may have a landing gear 27 (see FIG. 4A) configured to enable the landing system to launch or land on a runway in a horizontal configuration. The wing system 21 may include orientation thruster 24 for assisting wings system to separate with rocket system 100 during flighting. FIG. 2 is a side perspective view of the rocket and wings system, which illustrate the wings system holding the reusable rocket system.

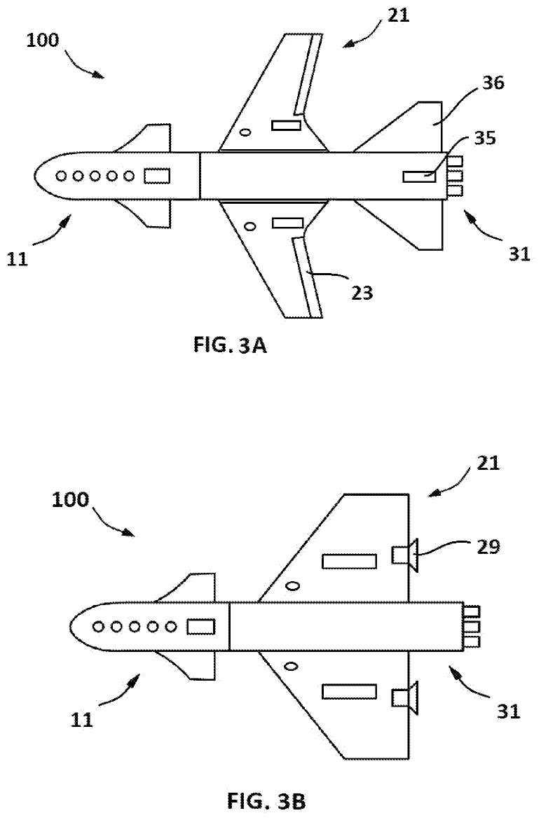

In some embodiment, as shown in FIG. 3A, the adjustable speed rocket and attachable wing system 100 may include a second small wing or glider wing 36, after the rocket booster 31 separates with payload or space shuttle 11 during flying, the rocket booster 31 may return or fly to a designated Earth location by performing the small wing or glider wing 36. In some embodiment, as shown in FIG. 3B, the attachable wing system may include one or more engines 29, and the engine system 29 may assist the whole rocket wings system 100 to fly at a low speed (e.g., 0.5˜3 Mach) and may assist the attachable wings 21 fly to a designated location after separating with the rocket system 100 during flying.

FIG. 4A illustrates the adjustable speed rocket booster 31 may include mounting actuators 33, one or more aerodynamic thruster 34, and the attachable wings system 21 may include mounting hardware 26, actuators 25 and landing gear system 27 may hide inside of the wing system when ascent and explore when decent to landing. The rocket booster's mounting actuators 33 may couple with the attachable wings system's mounting hardware 26 and actuators 25 to combine the rocket booster and the wings system together, see FIG. 4B, and there may be fuel and electrical conduits in the mounting system. Except this way, the readers should know, there are some other conventional ways to bundle the wings system 21 with the rocket system 100 together.

All parts of the rocket and wings system have aerodynamic surface to reduce the aerodynamic friction and drag during flying. The payload or space shuttle, reusable rocket, attachable wings system and glider wings etc. may include some aerodynamic coating (e.g., thermal protecting system) configured to provide heat resistance and thermal shielding from aerodynamic heating (e.g., super high-speed flighting and atmospheric returning).

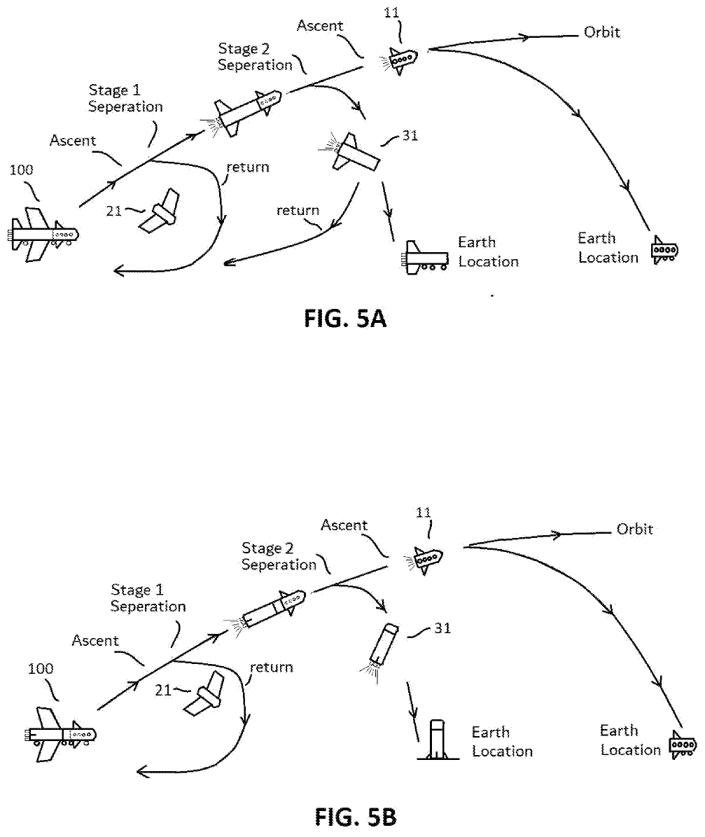

FIG. 5A is a timeline view of one embodiment of the adjustable speed rocket and attachable wings system 100 launching and landing methods. Firstly, the whole rocket system 100 locates on the ground in a horizontal configuration or in a vertical configuration, the adjustable speed rocket booster 31 propels the whole system to fly at a low speed (e.g., 0.5˜3 Mach), the income air and the attachable wings system 21 produce a lift force to perform whole system 100 to a designated high altitude. After reaches this altitude, because the air density is extremely low, the income air and attachable wings system 21 can not execute more lift force to power the payload or space shuttle to reach a higher altitude. A command occurred by the pre-settled program performs the attachable wings system 21 to separate with the whole rocket system 100, and the wings system 21 returns or flies to a designated position lands as a glider on a runway in a horizontal configuration. Another command initiates the reusable rocket system 31 to fully propulsion and powers the payload or space shuttle 11 to another higher designated altitude.

In some embodiment, the adjustable wings system 21 may include one or more engines 29, see FIG. 3B, and the engines may assist the whole system 100 to fly at a low speed (e.g., 0.5˜3 Mach) assists the attachable wings 21 fly to a designated location after separation with the rocket system 31 during flying. In some embodiment, the wing system' jet engines can not propel the whole rocket system 100 to a designated relatively high altitude, so the jet engines of wing systems 21 may collaborate with the adjustable speed rocket system 31 to power the whole rocket system 100 to the designated relatively high altitude. In some embodiment, the wings system's jet engines shut down, and the adjustable speed rocket booster 31 propels whole rocket system to the designated altitude at a low speed.

After the attachable wings system 21 separates with the whole rocket system 100, the rocket booster 31 propels the payload or space shuttle 11 to reach another designated location at rocket fully propulsion. When the payload or space shuttle 11 reaches to the designated location, another command executes the rocket booster 31 to separate with the payload or space shuttle 11, and the small wings or glider wings system 36 assists the rocket booster 31 to fly or glider to a designated Earth location. The payload or space shuttle 11 performs to orbit by its own propulsion system or flies to a designated Earth location lands as a glider or by its propulsion system and landing on a runway in the horizontal configuration.

In some embodiment, the whole rocket system 11 does not have the second small wings or glider wings, shown in FIG. 5B, the reusable rocket booster 31 lands on the ground in a vertical configuration after separation with the payload or space shuttle 11. Additionally, the FIG. 5C diagram illustrates the attachable wings system 21 does not detach from the whole rocket system 100 during flighting, the rocket booster 31 and wing system 21 together land a designated position on a runway in horizontal configuration.

In some embodiment, as shown in FIG. 5D, the whole rocket booster 31 may do not separate with the space shuttle 11 during flying. The whole rocket system 100 firstly fly and ascent at a low speed, the income air and the attachable wing system performs the whole system to a relative high altitude, at this altitude, the air density is extremely low compared with the Earth surface, then the rocket booster 31 performs fully propulsion force to power the space shuttle 11 to relative high altitude and at extremely high speed, and then decent and land to a designated Earth location on a runway in horizontal configuration. This mothed may reduce the long-distance travel time to one or half hour and the conventional economic plane usually require around 10 hours to travel the same distance.

There are some advantages compared the attachable wings system with the fixed wings. Firstly, the attachable wings' manufacture and maintenance can separate with the rockets' manufacture, so the rocket technology can not be leaked during manufacture or maintenance. Secondly, the rocket boosters work under an extremely high temperature situation, so the rocket booster maintenance frequency and time are far higher and longer than the wings system.

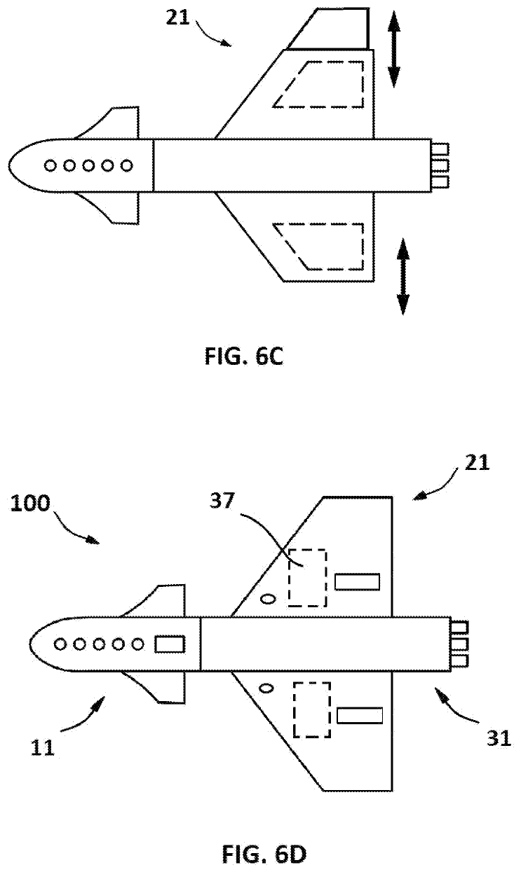

Additionally, the rocket booster not only is configured on one rocket wing system, also can be deposited on two or more rocket booster wings system (see FIG. 8). Finally, the rocket booster's lifespan is short than the wings system's lifespan, once the rocket boost is broken, the wing system still can be transferred to other rocket boosters to use, that helps to reduce the cost.

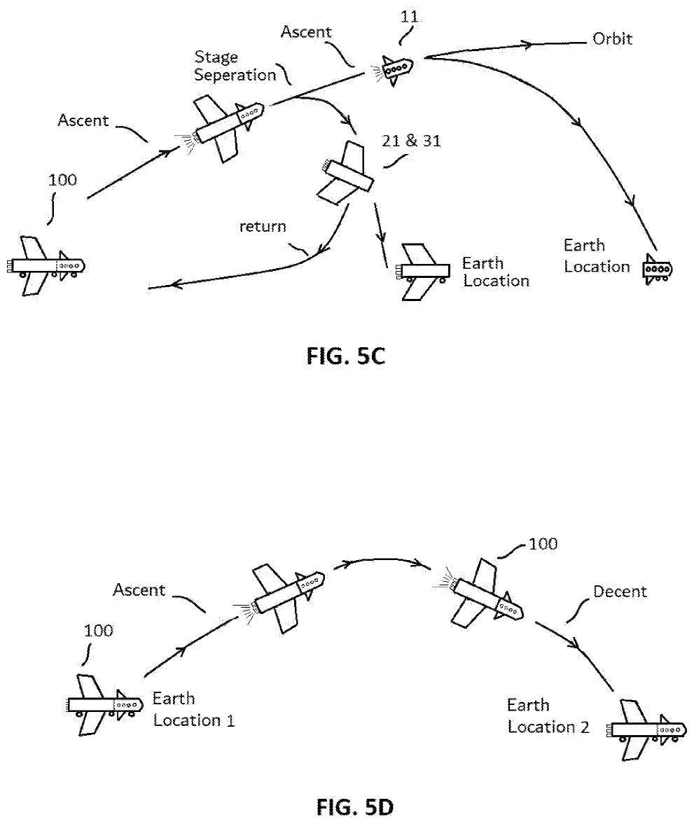

The FIG. 6A shows the rocket system 100 carry big or more than one payload or space shuttle 11, the attachable wing system 21 need to be configured to a middle position of the rocket system 100 for system balance and stability, part of the attachable wings system 21 is attached on the payload or space shuttle 11, another part of the attachable wings system 21 is attached on the rocket booster 31. When the rocket booster 31 preparing to separate with payload or space shuttle 11, the attachable wings system 21 may move backward to designated position for adjusting the rocket booster balance.

As shown in FIG. 6B and 6C, in some embodiment, the attachable wings system 21 may fold the wings or part of wings draws back into another part of wings before the rocket boost fly at fully propulsion configuration to reduce the aerodynamic surface to decrease the aerodynamic drag.

The attachable wings system 21 may include one or more fuel containers 37 for storing the rocket propellant, see FIG. 6D, and one or more tube or pipe connect the rocket booster and containers.

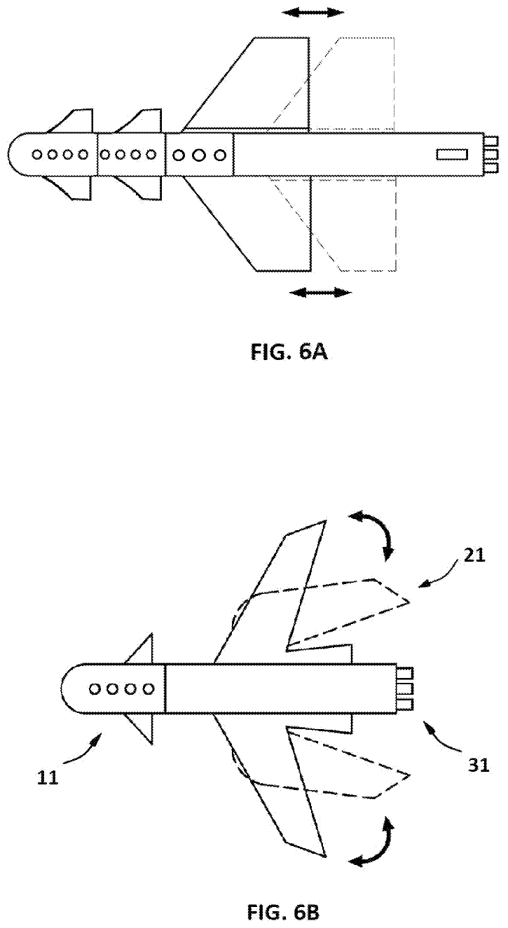

In some embodiment, as shown in FIG. 7, the rocket system 21 may be settled one or more jet engines 39 are bundled with the rocket booster 31 for propel the whole rocket and attachable wings system 100 to fly.

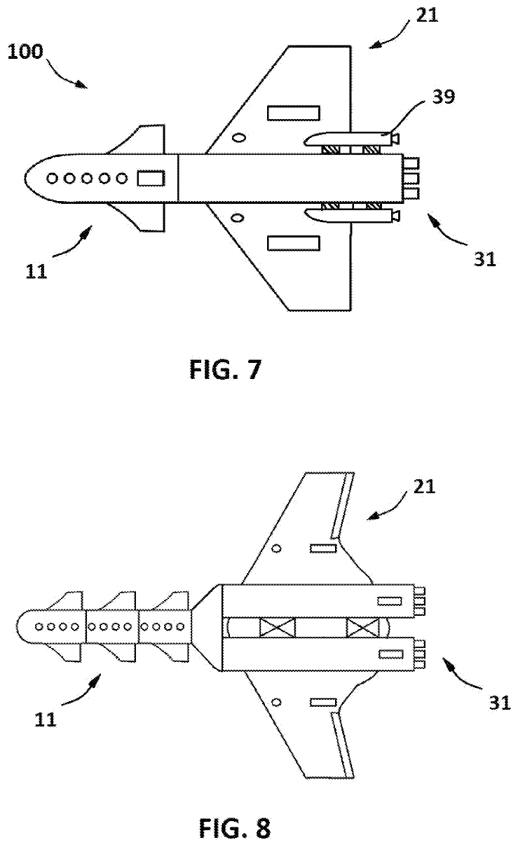

As shown in FIG. 9A and FIG. 9B, some parallel holders 281 are configured to deposited on the attachable wings system 21, these parallel holders 281 have mounting hardware 26 and actuator 25 for coupling with rocket booster, payload or space shuttle mounting actuator 33 for bundle the wings system 21 with the rocket booster 31, payload or space shuttle 11.

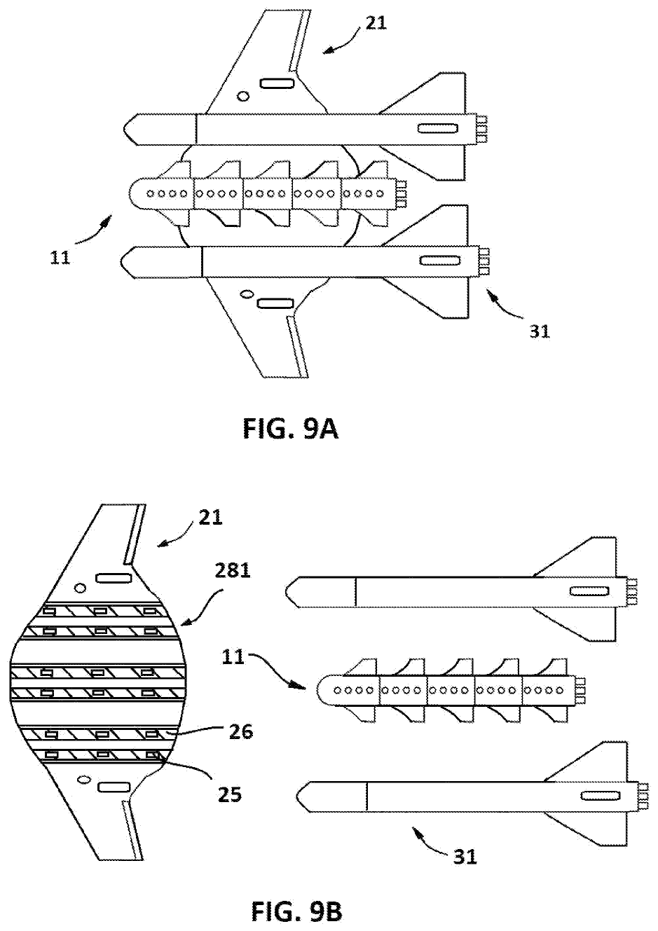

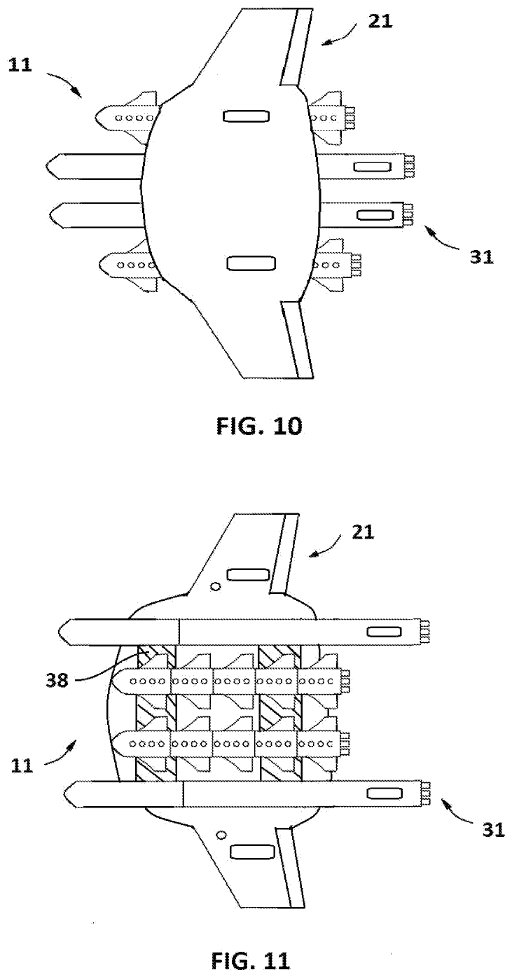

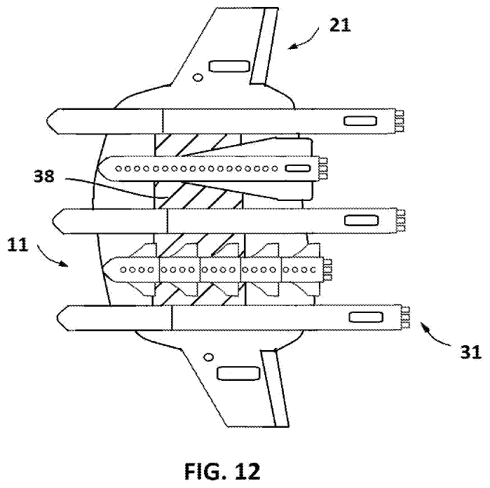

In some embodiment, as shown in FIG. 8, FIG. 9A, FIG. 10, FIG. 11, and FIG. 12, more than one rocket boosters 31 are parallelly configured on the attachable wing system 21 to produce more powerful propulsion to perform multiply payloads or space shuttles 11 for space travel or travel between different long distance Earth locations. There may have coupling hardware 38 between them, in some embodiment, the payload or space shuttle 11 are configured at the head of booster, as shown in FIG. 8, in some embodiment, the payloads or space shuttles paralleled with the rocket boosters, etc.

While the preceding detailed description references several examples and aspects, it will be understood that one of ordinary skill in the relevant art will be able to make various modification and changes to the described aspects without departing from the true spirit and scope thereof. It is also be understood if all elements or steps which are insubstantially different from the art in the claims but fulfill the substantially same functions, respectively, in substantially the same way to acquire the same result as what is claimed are within the scope of the disclosure.

1. A travel system comprising:
(a) An adjustable speed rocket system comprising:
an adjustable speed rocket booster has two opposite ends; and
at least one payload or space shuttle; and
the rocket booster and the payload or space shuttle are configured along a same axis;
(b) An attachable wings system comprising:
a center holder, and
wings are configured on two opposite sides of the center holder;
wherein the center holder configured with wings on two opposite sides is removable attached on the adjustable speed rocket booster and located between the two opposite ends of the booster; or
wherein a part of the center holder configured with wings on two opposite sides is removable attached on the payload or space shuttle and another part of the center holder configured with wings on two opposite sides is removable attached on the rocket booster.

2. The travel system of claim 1, wherein the adjustable speed rocket propels the whole rocket system fly at designated altitude at a low speed (0.5˜3 Mach), before the wings system separates with the rocket system.

3. The travel system of claim 1, wherein after launching the rocket system, the travel system flies at a low speed, an income air and the attachable wings system execute a lift force to propel the whole travel system to reach a designated altitude.

4. The travel system of claim 1, wherein when the rocket system reaches to a designated altitude, the air density is extremely low—, and the income-air and wings system can not execute more strong lift force to propel whole system to reach higher.

5. The travel system of claim 1, wherein after the whole travel system reach to a designated altitude, the wings system separates with the whole travel system and land as a glider on a runway in horizontal configuration.

6. The travel system of claim 1, wherein the rocket system ignites fully propulsion system to propel payload to a designated altitude after the wings system separate with the whole rocket system.

7. The travel system of claim 1, wherein the rocket booster may include a small wing system or glider wings system to land a designated location on a runway in a horizontal configuration after separate with the payload or space shuttle.

8. The travel system of claim 1, wherein the rocket may not separate with the space shuttle, and directly land a designated Earth location on a runway in a horizontal configuration.

9. A travel system comprising:
(a) An adjustable speed rocket system comprising:
an adjustable speed rocket booster; and
at least one payload or space shuttle were deposited on the rocket booster before the rocket system launch;
(b) An attachable wings system comprising:
a center holder; and
wings are configured on two opposite sides of the center holder;
wherein the center holder of the attachable wings system attaches on the rocket system before rocket launch and the center holder of attachable wings system detaches from the rocket system when the center holder and rocket system reach to the sky (space) area having a designated air density.

10. A travel system comprising:
(a) An adjustable speed rocket system comprising:
an adjustable speed rocket booster; and
at least one payload or space shuttle were deposited on the rocket booster before the rocket system launch; and
(b) A small wings system or slider wings system is configured on the rocket booster;
(c) An attachable wings system comprising:
a center holder; and
wings are configured on two opposite sides of the center holder;
wherein the center holder of attachable wings system attaches the rocket system before rocket launch and detaches from rocket system during flying;
wherein the rocket booster separates with payload or space shuttle after the wings system detaches from the rocket system and the small wings system or slider wings system assist the rocket booster flies to a designated Earth location on a runway in a horizontal position.

11. A travel system comprising:
(a) A rocket system comprising:
at least two rocket boosters; and
at least one payload or space shuttle;
(b) An attachable wings system comprising:
at least two holders parallel settle on the wings system;
wings are configured on two outside holders of the parallel holders;
wherein at least one payload or space shuttle is deposited on the rocket booster before the rocket system launch;
wherein two or more rocket boosters are parallelly and respectively deposited on the parallel holders of the wings system.

12-16. (canceled)
